(19) United States
(12) Patent Application Publication
(10) Pub. No.: US 2011/0013090 A1
(43) Pub. Date: Jan. 20, 2011

(54) BACKLIGHT DEVICE, DISPLAY DEVICE, AND TELEVISION RECEIVER

(75) Inventor: Shinji Matsumoto, Osaka-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/920,878

(22) PCT Filed: Oct. 10, 2008
(86) PCT No.: PCT/JP2008/068456

§ 371 Date: Sep. 3, 2010

(30) Foreign Application Priority Data
Mar. 12, 2008 (JP) 2008-061974

(51) Int. Cl. H04N 5/44; G09G 5/10; G02F 1/13357

(52) U.S. Cl. 348/725; 345/690; 362/97.1; 348/E05.096

(57) ABSTRACT

A backlight device in which falling of a light source from a connector member is suppressed. The backlight device (20) comprises hot-cathode fluorescent lamps (23) where connector parts (23a) having two terminals (23b) are provided at the both ends, a chassis (21) disposed on the back surface side of the hot-cathode fluorescent lamps, and fluorescent lamp sockets (24) which fix the hot-cathode fluorescent lamps to the chassis. At each fluorescent lamp socket, an insertion part (24c) for inserting a terminal of a hot-cathode fluorescent lamp is formed. The insertion part is formed so that the direction of removing the hot-cathode fluorescent lamp from the socket faces an upper side than the horizontal direction when the chassis is disposed vertically.

### TECHNICAL FIELD

The present invention relates to a backlight device, a display device, and a television receiver, and more particularly, to a backlight device, a display device and a television receiver that include a connector member for fixing a light source.

### BACKGROUND ART

Conventionally, a backlight device that includes a connector member for fixing a light source is known (e.g., see a patent document 1). This patent document 1 discloses a backlight unit (backlight device) that includes: a cold-cathode fluorescent lamp (light source) on both end portions of which electricity supply terminals (lamp base portions) are disposed; a housing (chassis) that is disposed on a rear-surface side of the cold-cathode fluorescent lamp; and a lamp holder (connector member) for fixing the cold-cathode fluorescent lamp to the housing. In the above patent document 1, the lamp holder is provided with a pair of grip plates that are so disposed as to face each other and grip the electricity supply terminal of the cold-cathode fluorescent lamp. And, in mounting and demounting the cold-cathode fluorescent lamp onto and from the lamp holder, the pair of the grip plates are opened and the cold-cathode fluorescent lamp is mounted and demounted.

Besides, conventionally, for example, a light source such as a hot-cathode fluorescent lamp and the like, on both end portions of which lamp base portions having two terminals are disposed, is known. Such a hot-cathode fluorescent lamp (light source) often has a diameter larger than the cold-cathode fluorescent lamp.

Besides, a backlight device, which includes a hot-cathode fluorescent lamp (light source) on both end portions of which lamp base portions having two terminals are disposed as described above, is known. FIGS. 16 to 20 are diagrams for describing a backlight device as a conventional example which includes the hot-cathode fluorescent lamp on both end portions of which lamp base portions having two terminals are disposed.

This backlight device 500 as the conventional example, as shown in FIG. 16, includes: a hot-cathode fluorescent lamp (light source) 501 on both end portions of which lamp base portions 501a having two terminals 501b (see FIG. 17) are disposed; a chassis 502 that is disposed on a rear-surface side of the hot-cathode fluorescent lamp 501; and a fluorescent lamp socket 503 for fixing the hot-cathode fluorescent lamp 501 to the chassis 502. In the backlight device 500 as the conventional example, as shown in FIG. 18, the fluorescent lamp socket 503 is provided with an insertion portion 503a into which the terminal 501b of the hot-cathode fluorescent lamp 501 is inserted. This insertion portion 503a is formed in such a way that in a state (state in FIGS. 16 and 18) where the chassis 502 is vertically disposed (longitudinally disposed), a direction, in which the hot-cathode fluorescent lamp 501 is mounted onto the fluorescent lamp socket 503, and a direction, in which the hot-cathode fluorescent lamp 501 is demounted from the fluorescent lamp socket 503, match a horizontal direction.

And, in a case where the hot-cathode fluorescent lamp 501 is mounted onto the fluorescent lamp socket 503, as shown in FIGS. 18 and 19, the terminals 501b of the hot-cathode fluorescent lamp 501 are inserted into the insertion portion 503a of the fluorescent lamp socket 503. Thereafter, the terminals 501b (hot-cathode fluorescent lamp 501) are rotated by 90 degrees in an arrow E direction (circumferential direction of the hot-cathode fluorescent lamp 501), so that the hot-cathode fluorescent lamp 501 is mounted onto the fluorescent lamp socket 503 as shown in FIG. 20. Here, the structure of the fluorescent lamp socket 503 is disclosed in a patent document 2, for example.

In the backlight device 500 as the conventional example, by structuring the hot-cathode fluorescent lamp 501 and the fluorescent lamp socket 503 as described above, it is not necessary to open the grip plates of the lamp holder (connector member) unlike the backlight device in the above patent document 1 in which the grip plates of the lamp holder are opened in mounting and demounting the cold-cathode fluorescent lamp (light source), so that even in a case where the light source (hot-cathode fluorescent lamp 501) that has a relatively large diameter is used, it is possible to mount and demount the light source (hot-cathode fluorescent lamp 501) onto and from the fluorescent lamp socket 503.

Here, in the backlight device 500 as the conventional example, in the case where the hot-cathode fluorescent lamp 501 is mounted and demounted, usually, the mounting and demounting are performed in a state in which the chassis 502 is vertically disposed (longitudinally disposed). Especially, in recent years, backlight devices are going large as liquid crystal display devices are going large; in the case where a light source such as a hot-cathode fluorescent lamp and the like is mounted and demounted, the mounting and demounting are performed in the state in which the chassis is vertically disposed.

Patent document: JP-A-2007-157565
Patent document: JP-A-1998-223015

### DISCLOSURE OF THE INVENTION

### Problems to be Solved by the Invention

However, in the backlight device 500 as the conventional example shown in FIGS. 16 to 20, because the insertion portion 503a of the fluorescent lamp socket 503 is formed in such a way that in the state in which the chassis 502 is vertically disposed (longitudinally disposed), the direction, in which the hot-cathode fluorescent lamp 501 is demounted from the fluorescent lamp socket 503, matches the horizontal direction, if the hot-cathode fluorescent lamp 501 is rotated 90 degrees by vibration and the like from outside to change from a state in FIG. 20 into a state in FIG. 19, there is a problem that the hot-cathode fluorescent lamp 501 is likely to come off and fall from the fluorescent lamp socket 503.

Besides, likewise, in the case where the hot-cathode fluorescent lamp 501 is mounted and demounted in the state in which the chassis 502 is vertically disposed, there is a problem that the hot-cathode fluorescent lamp 501 is likely to fall from (slide down) the fluorescent lamp socket 503 (insertion portion 503a) because of its weight.

The present invention has been made to solve the above problems, and it is an object to provide a backlight device, a display device and a television receiver that are able to prevent a light source from falling from a connector member.

### Means for Solving the Problem

To achieve the object, a backlight device according to a first aspect of the present invention includes: a light source on both end portions of which lamp base portions each having a plurality of terminals are disposed; a chassis that is disposed on a rear-surface side of the light source; and a connector member that fixes the light source to the chassis; wherein the connector member is provided with an insertion portion into which the terminal of the light source is inserted; and the insertion portion is formed in such a way that in a state in which the chassis is vertically disposed, a direction in which the light source is demounted from the connector member faces an upper side than a horizontal direction.

In this backlight device according to the first aspect, as described above, the connector member is provided with an insertion portion into which the terminal of the light source is inserted; and the insertion portion is formed in such a way that in the state in which the chassis is vertically disposed, the direction in which the light source is demounted from the connector member faces an upper side than a horizontal direction, so that because it is possible to prevent the terminal of the light source from coming off the insertion portion of the connector member, it is possible to prevent the light source from falling from the connector member.

In the backlight device according to the first aspect, preferably, the insertion portion is formed in such a way that in the state in which the chassis is vertically disposed, the direction in which the light source is demounted from the connector member is inclined toward an upside with respect to a direction away from the chassis. According to this structure, it is possible to easily form the insertion portion in such a way that in the state in which the chassis is vertically disposed (longitudinally disposed), the direction in which the light source is demounted from the connector member faces the upper side than the horizontal direction. Besides, because the insertion portion is formed in such a way that in the state in which the chassis is vertically disposed, the direction in which the light source is demounted from the connector member is inclined toward the upside with respect to the direction away from the chassis, unlike the case where the insertion portion faces an upside in the vertical direction in the state in which the chassis is vertically disposed (longitudinally disposed), in mounting and demounting the light, it is possible to prevent the light source from coming into contact with an upper surface of the chassis and prevent the light source from coming into contact with another light source arranged over the light source. In this way, it is possible to easily mount and demount the light source.

In the backlight device according to the first aspect, preferably, a first claw portion and a second claw portion, which have a first insertion surface and a second insertion surface respectively which constitute the insertion portion, are so formed on the connector member as to face each other; the first claw portion is disposed over the second claw portion; and the second claw portion has a length longer than the first claw portion. According to this structure, it is possible to easily form the insertion portion in such a way that in the state in which the chassis is vertically disposed (longitudinally disposed), the direction in which the light source is demounted from the connector member faces the upper side than the horizontal direction.

In the backlight device in which the first claw portion and the second claw portion, which have the first insertion surface and the second insertion surface respectively, are formed on the connector member, preferably, an end portion of the first insertion surface of the first claw portion is provided with a first end surface; an end portion of the second insertion surface of the second claw portion is provided with a second end surface; and the first end surface of the first claw portion and the second end surface of the second claw portion are so formed as to be away from each other toward outside of the insertion portion. According to this structure, it is possible to easily insert the light source into the insertion portion of the connector member.

In this case, preferably, the second end surface of the second claw portion is so formed as to be inclined toward an upside with respect to a direction away from the chassis in the state in which the chassis is vertically disposed. According to this structure, even in a case where the terminal of the light source is moved to the end portions (first end surface and second end surface) of the insertion portion by vibration from outside, it is possible to prevent the terminal of the light source from coming off (moving to outside of the second end surface) the second end surface. In this way, it is possible to prevent the light source from coming off and fall from the connector member.

In the backlight device according to the first aspect, preferably, a cover member that is fixed to the chassis and covers the connector member is further included; wherein a portion of the cover member, which is situated in a direction in which the insertion portion extends, is provided with an opening portion. According to this structure, in mounting and demounting the light source onto and from the connector member, because it is not necessary to demount the cover member, it is possible to easily mount and demount the light source onto and from the connector member.

In the backlight device according to the first aspect, preferably, the first claw portion and the second claw portion, which have the first insertion surface and the second insertion surface respectively which constitute the insertion portion, are so formed on the connector member as to face each other; the first claw portion and the second claw portion are provided with an arc-shape first groove portion and an arc-shape second groove portion respectively that are connected to the insertion portion; and the terminals of the light source are inserted into the insertion portion of the connector member, rotated by a predetermined angle in a circumferential direction of the light source to be moved into the first groove portion and the second groove portion, so that the light source is mounted on the connector member. According to this structure, even in a case where the light source has a relatively large diameter, it is possible to easily mount the light source onto the connector member.

In this case, preferably, the predetermined angle by which the terminals of the light source are rotated is smaller than 90 degrees. According to this structure, it is possible to more easily mount the light source onto the connector member than a case where the terminal of the light source is rotated by 90 degrees or more to mount the light source onto the connector member.

In the backlight device according to the first aspect, preferably, the connector member is provided with a limit portion that limits movement of the light source in an axis direction of the light source. According to this structure, in the state in which the light source is mounted on the connector member, it is possible to limit movement of the light source in the axis direction of the light source with respect to the connector member. Besides, in mounting and demounting the light source onto and from the connector member, it is possible to easily mount the light source onto a desired position of the connector member.

A display device according to a second aspect of the present invention includes: the above backlight device; and a display panel that is illuminated by the backlight device. According to this structure, it is possible to obtain a display device that is able to prevent the light source from falling from the connector member.

A television receiver according to a third aspect of the present invention includes: the above display device; a cabinet that houses the display device; a tuner; and a speaker. According to this structure, it is possible to obtain a television receiver that is able to prevent the light source from falling from the connector member.

### ADVANTAGES OF THE INVENTION

As described above, according to the present invention, it is possible to easily obtain a backlight device, a display device and a television receiver that are able to prevent a light source from falling from a connector member.

### BRIEF DESCRIPTION OF THE DRAWINGS

FIG. 1 is an exploded perspective view showing a whole structure of a liquid crystal television receiver that includes a backlight device according to an embodiment of the present invention.

FIG. 2 is an exploded perspective view showing a structure of a liquid crystal display device that includes a backlight device according to an embodiment of the present invention.

FIG. 3 is a perspective view showing a structure of a hot-cathode fluorescent lamp of the backlight device shown in FIG. 2.

FIG. 4 is a perspective view showing a structure of the backlight device shown in FIG. 2.

FIG. 5 is an exploded perspective view showing a structure of the backlight device shown in FIG. 2.

FIG. 6 is a perspective view showing a structure of a connector member of the backlight device shown in FIG. 2.

FIG. 7 is a side view showing a structure of the connector member of the backlight device shown in FIG. 2.

FIG. 8 is a perspective view showing a structure of a cylindrical member of the connector member of the backlight device shown in FIG. 2.

FIG. 9 is a perspective view showing an end portion of and portions around the hot-cathode fluorescent lamp of the backlight device shown in FIG. 2.

FIG. 10 is a perspective view showing an end portion of and portions around the hot-cathode fluorescent lamp of the backlight device shown in FIG. 2.

FIG. 11 is a sectional view for describing a process for mounting the hot-cathode fluorescent lamp onto the connector member of the backlight device shown in FIG. 2.

FIG. 12 is a sectional view for describing a process for mounting the hot-cathode fluorescent lamp onto the connector member of the backlight device shown in FIG. 2.

FIG. 13 is a sectional view for describing a process for mounting the hot-cathode fluorescent lamp onto the connector member of the backlight device shown in FIG. 2.

FIG. 14 is a perspective view showing a structure of a backlight device according to a first modification of the present invention.

FIG. 15 is a perspective view showing a structure of a backlight device according to a second modification of the present invention.

FIG. 16 is a perspective view showing a structure of a backlight device as a conventional example.

FIG. 17 is a perspective view showing a structure of a hot-cathode fluorescent lamp of the backlight device as the conventional example shown in FIG. 16.

FIG. 18 is a sectional view for describing a process for mounting the hot-cathode fluorescent lamp onto a connector member of the backlight device as the conventional example shown in FIG. 16.

FIG. 19 is a sectional view for describing a process for mounting the hot-cathode fluorescent lamp onto the connector member of the backlight device as the conventional example shown in FIG. 16.

FIG. 20 is a sectional view for describing a process for mounting the hot-cathode fluorescent lamp onto the connector member of the backlight device as the conventional example shown in FIG. 16.

### LIST OF REFERENCE SYMBOLS

1 liquid crystal television receiver (television receiver)
2 front cabinet (cabinet)
3 rear cabinet (cabinet)
4 speaker
5 tuner
10 liquid crystal display device (display device)
20 backlight device
21, 31 chassis
23 hot-cathode fluorescent lamp (light source)
23a lamp base portion
23b terminal
24, 34 fluorescent lamp sockets (connector members)
24c insertion portion
24d claw portion (first claw portion, limit portion)
24e claw portion (second claw portion, limit portion)
24f insertion surface (first insertion surface)
24g insertion surface (second insertion surface)
24h end surface (first end surface)
24i end surface (second end surface)
24j groove portion (first groove portion)
24k groove portion (second groove portion)
25 cover member
25a opening portion
120 liquid crystal display panel (display panel)

### BEST MODE FOR CARRYING OUT THE INVENTION

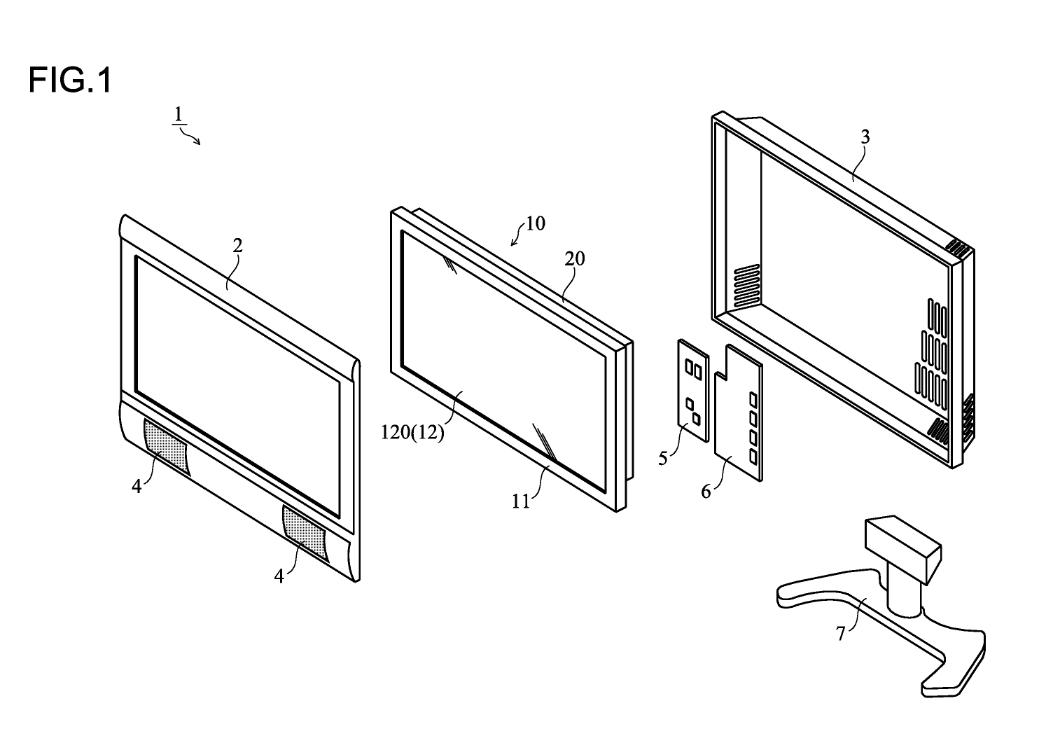

First, a structure of a liquid crystal television receiver 1 that includes a backlight device 20 according to an embodiment of the present invention is described with reference to FIGS. 1 to 10. Here, the liquid crystal television receiver 1 is an example of a “television receiver” in the present invention.

The liquid crystal television receiver 1 that includes the backlight device 20 according to an embodiment of the present invention, as shown in FIG. 1, includes: a liquid crystal display device 10 that includes the backlight device 20; a front cabinet 2 and a rear cabinet 3 that house the liquid crystal display device 10; a speaker 4 that is mounted on the front cabinet 2; a tuner 5; a power supply 6; and a support member 7. As for the front cabinet 2, the rear cabinet 3, the speaker 4, the tuner 5, the power supply 6 and the support member 7, because it is possible to use devices that are conventionally generally used, these are briefly described. Here, the liquid crystal display device 10 is an example of a “display device” in the present invention; and the front cabinet 2 and the rear cabinet 3 are examples of a “cabinet” in the present invention.

The front cabinet 2 and the rear cabinet 3 house the liquid crystal display device 10, the tuner 5 and the power supply 6; and are supported by the support member 7. Besides, the tuner 5 has a function to generate an image signal and a voice signal for a predetermined channel from a received electric wave. The speaker 4 has a function to output a voice based on a voice signal generated by the tuner 5. The power supply 6 is so structured as to supply electric power to the liquid crystal display device 10, the speaker 4 and the tuner 5. Here, the speaker 4, the tuner 5 and the power supply 6 may be built in the liquid crystal display device 10.

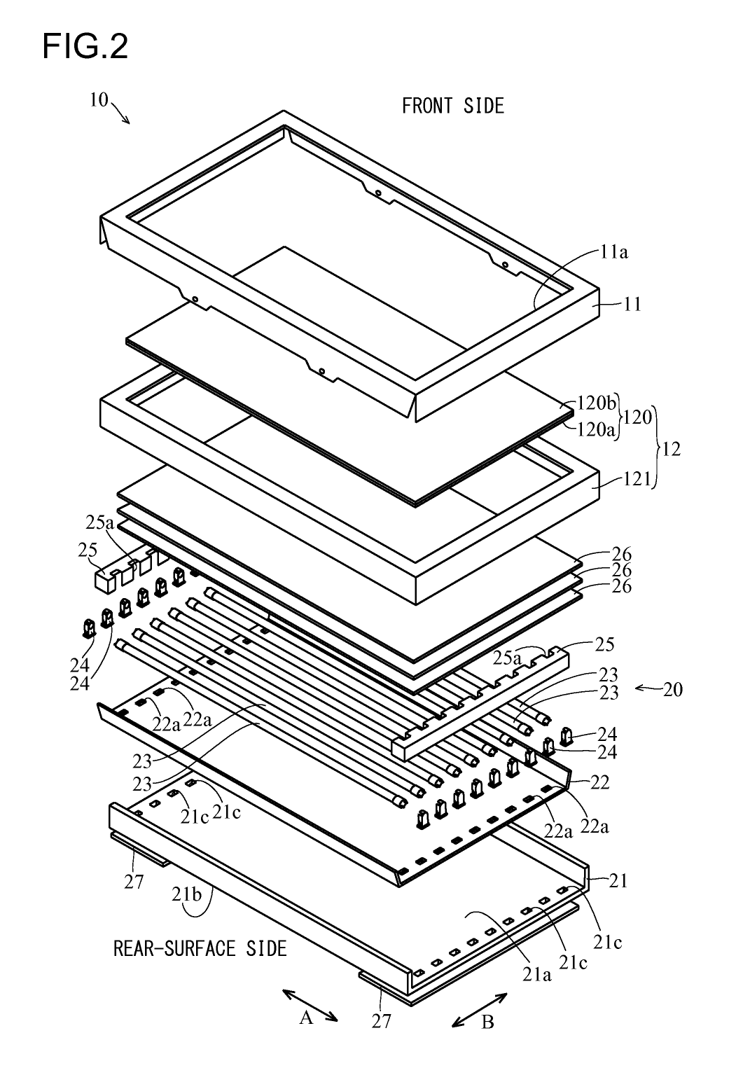

The liquid crystal display device 10, as shown in FIG. 2, is composed of: a bezel 11 that has an opening portion 11a; a liquid crystal display panel unit 12 whose circumferential portion is covered by the bezel 11; and a direct-type backlight device 20 that is disposed on a rear-surface side of the liquid crystal display panel unit 12.

The liquid crystal display panel unit 12 is composed of a liquid crystal display panel 120; and a chassis 121 that supports a circumferential portion of the liquid crystal display panel 120. The liquid crystal display panel 120 includes: an AM board (active matrix board) 120a; and an opposite board 120b that is so disposed as to face the AM board 120a. And, the liquid crystal display panel 120 functions as a display panel by being illuminated by the backlight device 20. Here, the liquid crystal display panel 120 is an example of a “display panel” in the present invention.

In the backlight device 20, on a front-surface 21a side of the chassis 21, a reflection sheet 22, a hot-cathode fluorescent lamp 23, a plurality of fluorescent lamp sockets 24 that are each mounted on both end portions of the hot-cathode fluorescent lamp 23, a pair of cover members 25 that cover the fluorescent lamp socket 24 and a plurality of optical sheets 26 are arranged. Besides, in the backlight device 20, on a rear-surface 21b side of the chassis 21, a pair of inverter boards 27 that are electrically connected to the fluorescent lamp sockets 24 are arranged. Here, the hot-cathode fluorescent lamp 23 is an example of a “light source” in the present invention; and the fluorescent lamp socket 24 is an example of a “connector member” in the present invention. Besides, in the following description, a longer-edge direction of the chassis 21 is called an A direction; and a shorter-edge direction of the chassis 21 is called a B direction.

The chassis 21 is composed of a metal plate that is formed of an aluminum plate and the like. This chassis 21 has a pair of side portions that are formed by perpendicularly folding the metal plate toward the front side. Here, the chassis 21 may be provided with four side portions by folding the four end portions in the A direction and the B direction of the metal plate. Besides, in the vicinity of both end portions of the chassis 21 in the A direction, a plurality of insertion holes 21c are formed at predetermined intervals in the B direction.

The reflection sheet 22 is composed of a sheet member that is able to reflect light irregularly; and placed on the front surface 21a of the chassis 21. Besides, in the vicinity of both end portions of the reflection sheet 22 in the A direction, a plurality of insertion holes 22a are formed at positions corresponding to the plurality of insertion holes 21c of the chassis 21. The sheet member that constitutes the reflection sheet 22 is formed of a PET (polyethylene terephthalate) resin and the like, for example.

The hot-cathode fluorescent lamp 23 is composed of a plurality of straight tube fluorescent lamps; and is arranged in front of the reflection sheet 22. In other words, the rear-surface side portions of a plurality of hot-cathode fluorescent lamps 23 are covered by the reflection sheet 22. In this way, part of the light emitted from the hot-cathode fluorescent lamp 23 is irregularly reflected by the reflection sheet 22 to advance to the front side. Besides, the plurality of hot-cathode fluorescent lamps 23 are each so disposed as to extend along the A direction and arranged a predetermined interval away from each other along the B direction.

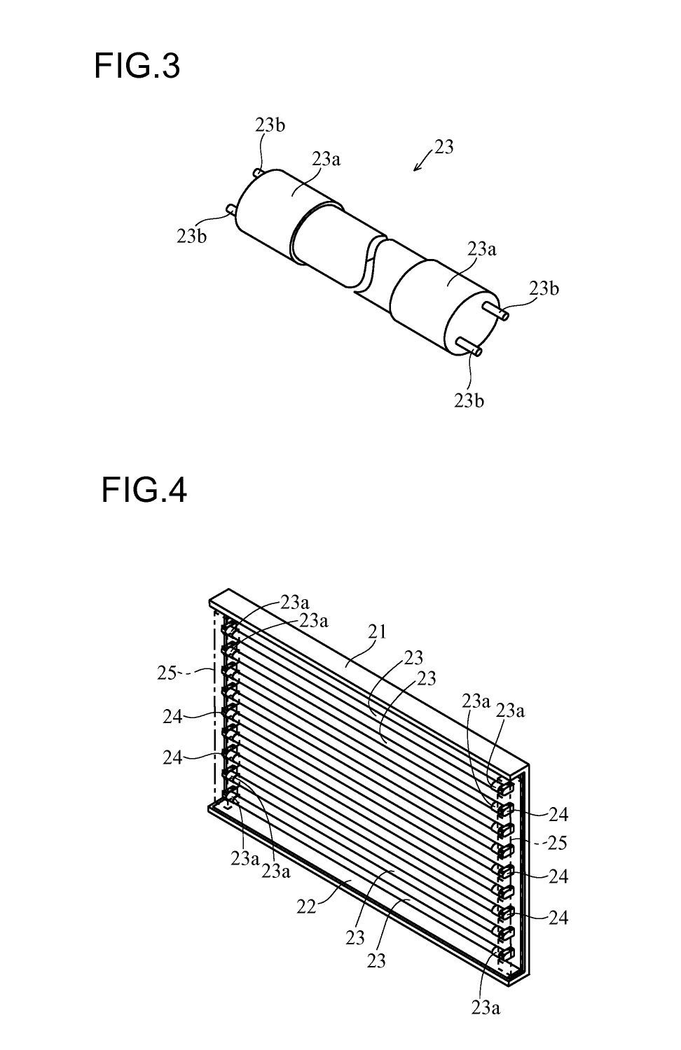

Besides, as shown in FIG. 3, lamp base portions 23a are disposed on both end portions of each of the hot-cathode fluorescent lamp 23. Besides, two terminals 23b are formed on each lamp base portion 23a.

Besides, on a pair of lamp base portions 23a of the hot-cathode fluorescent lamp 23, as shown in FIG. 4, a pair of fluorescent lamp sockets 24, which fix the hot-cathode fluorescent lamp 23 to the chassis 21 and are electrically connected to the hot-cathode fluorescent lamp 23, are mounted. The pair of fluorescent lamp sockets 24 are so formed as to have a symmetrical shape with respect to the A direction (see FIG. 2).

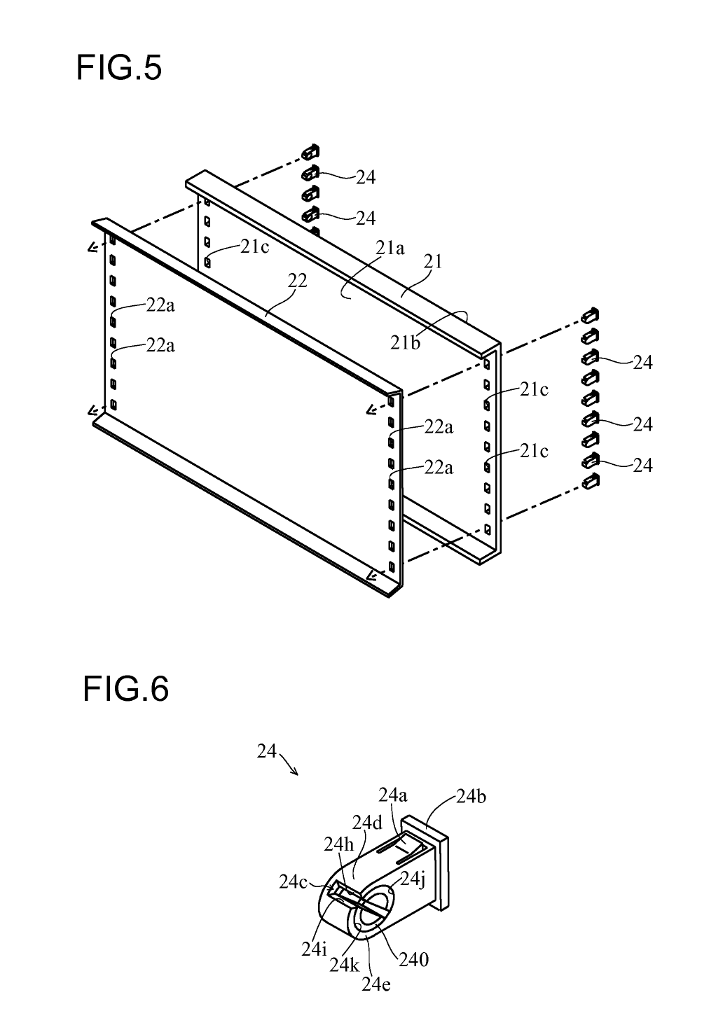

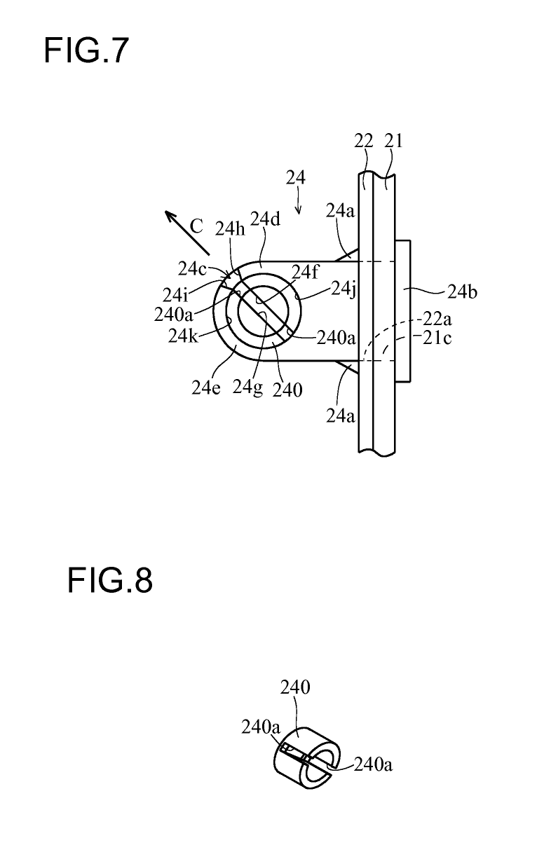

Besides, the fluorescent lamp socket 24, as shown in FIG. 5, is inserted into the insertion hole 21c of the chassis 21 and the insertion hole 22a of the reflection sheet 22 from the rear-surface 21b side of the chassis 21. Specifically, the fluorescent lamp socket 24, as shown in FIGS. 6 and 7, is provided with an engagement portion 24a and a plate-shape portion 24b. And, as shown in FIG. 7, the fluorescent lamp socket 24 is inserted into the insertion holes 21c and 22a, so that the chassis 21 and the reflection sheet 22 are sandwiched between the engagement portion 24a and the plate-shape portion 24b of the fluorescent lamp socket 24. In this way, the fluorescent lamp socket 24 is fixed to the chassis 21.

Here, in the present embodiment, the fluorescent lamp socket 24, as shown in FIGS. 6 and 7, is provided with an insertion portion 24c into which the terminal 23b (see FIG. 3) of the hot-cathode fluorescent lamp 23 is inserted. The insertion portion 24c is formed in such a way that in a state (states in FIGS. 1, 4, and 7) where the chassis 21 is vertically disposed (longitudinally disposed), a direction (arrow C direction (see FIG. 7)), in which the hot-cathode fluorescent lamp 23 (see FIG. 3) is demounted from the fluorescent lamp socket 24, is inclined toward an upside with respect to a direction away from the chassis 21. In other words, in the present embodiment, the insertion portion 24c is formed in such a way that in the state in which the chassis 21 is vertically disposed (longitudinally disposed), the direction, in which the hot-cathode fluorescent lamp 23 is demounted from the fluorescent lamp socket 24, faces an upper side than a horizontal direction and a direction inclined to a vertical direction.

Besides, a claw portion 24d and a claw portion 24e are so formed on the fluorescent lamp socket 24 as to face each other. These claw portions 24d and 24e have a function to limit movement of the hot-cathode fluorescent lamp 23 (see FIG. 2) in the A direction. Besides, the claw portion 24d is disposed over the claw portion 24e. Here, the claw portion 24d is an example of a “first claw portion” and a “limit portion” in the present invention; the claw portion 24e is an example of a “second claw portion” and a “limit portion” in the present invention.

Besides, in the present embodiment, the claw portion 24e is so formed as to have a length longer than the claw portion 24d.

Besides, as shown in FIG. 7, the claw portions 24d and 24e have insertion surfaces 24f and 24g, respectively; and the insertion portion 24c is composed of the insertion surfaces 24f and 24g. Here, the insertion surface 24f is an example of a “first insertion surface” in the present invention; the insertion surface 24g is an example of a “second insertion surface” in the present invention.

Besides, an outer-side end portion (end portion in an arrow C direction side) of the insertion surface 24f of the claw portion 24d is provided with an end surface 24h; and an outer-side end portion (end portion in the arrow C direction side) of the insertion surface 24g of the claw portion 24e is provided with an end surface 24i. And, the end surface 24h of the claw portion 24d and the end surface 24i of the claw portion 24e are so formed as to be away from each other toward outside (arrow C direction) of the insertion portion 24c. Here, the end surface 24h is an example of a “first end surface” in the present invention and the end surface 24i is an example of a “second end surface” in the present invention.

Besides, the end surface 24i of the claw portion 24e is so formed as to be inclined toward an upside with respect to a direction away from the chassis 21 in the state in which the chassis 21 is vertically disposed (longitudinally disposed).

Besides, the claw portions 24d and 24e are provided with arc-shape groove portions 24j and 24k respectively that are connected to the insertion portion 24c. A resin cylindrical member 240 is housed in the groove portions 24j and 24k. The cylindrical member 240, as shown in FIG. 8, is provided with two slit portions 240a. Here, the groove portion 24j is an example of a “first groove portion” in the present invention; and the groove portion 24k is an example of a “second groove portion” in the present invention.

Besides, the cylindrical member 240 is formed rotatably in a circumferential direction of the cylindrical member 240 in the groove portions 24j and 24k. Besides, the cylindrical member 240 is so composed as to be locked when engagement portions, not shown, engage with the claw portions 24d and 24e in a state in which the two slit portions 240a are arranged in a vertical direction. In this way, it is possible to prevent the cylindrical member 240 from being rotated by vibration and the like.

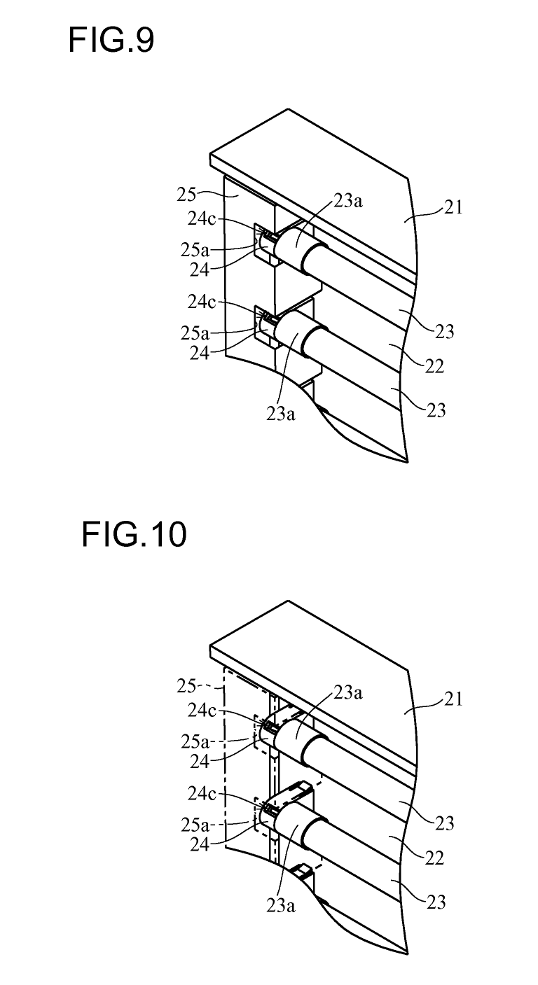

Besides, as shown in FIGS. 9 and 10, the cover member 25 is so fixed to the chassis 21 as to cover the fluorescent lamp socket 24. The cover member 25 has a function to prevent dust and the like from invading between the fluorescent lamp socket 24 and the hot-cathode fluorescent lamp 23.

Besides, in the present embodiment, an opening portion 25a is formed through a portion of the cover member 25 that is situated in a direction (arrow C direction (see FIG. 7)) in which the insertion portion 24c of the fluorescent lamp socket 24 extends.

As shown in FIG. 2, the optical sheet 26 is composed of a lens sheet, a diffusion sheet and the like; and is disposed in front of the hot-cathode fluorescent lamp 23. Collection, diffusion and the like of light emitted from the hot-cathode fluorescent lamp 23 are performed by the optical sheet 26.

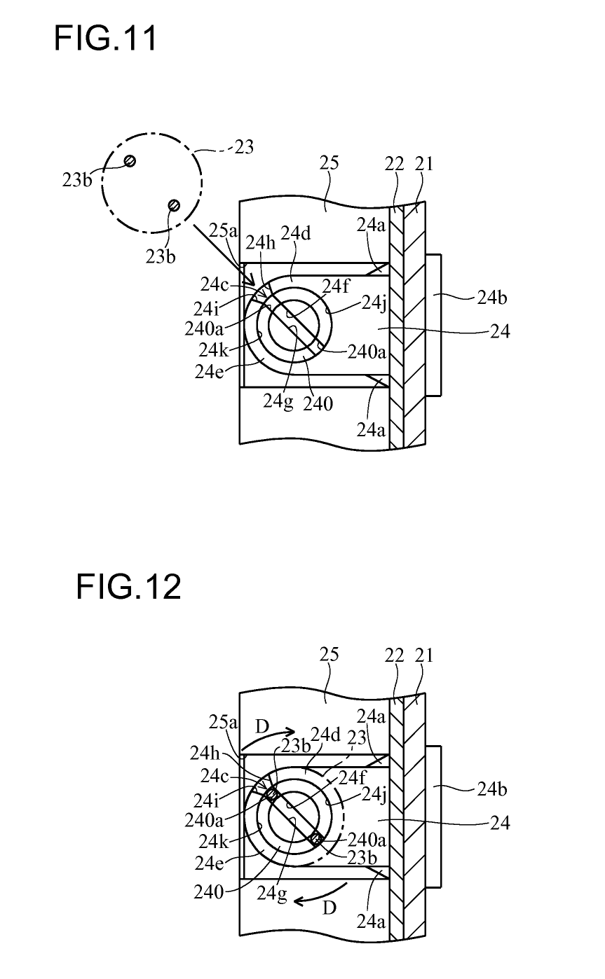

Next, a process for mounting the hot-cathode fluorescent lamp 23 onto the fluorescent lamp socket 24 of the backlight device 20 according to an embodiment of the present invention is described with reference to FIGS. 11 to 13.

First, as shown in FIG. 11, the terminals 23b of the hot-cathode fluorescent lamp 23 are inserted into the insertion portion 24c of the fluorescent lamp socket 24 in the state in which the chassis 21 is vertically disposed (longitudinally disposed). At this time, the terminal 23b of the hot-cathode fluorescent lamp 23 is inserted in a diagonally downward direction. Here, the cover member 25, as shown in FIG. 11, may be mounted or demounted on or from the chassis 21.

In this way, as shown in FIG. 12, a state in which the terminals 23b of the hot-cathode fluorescent lamp 23 are inserted in the insertion portion 24c (slit portion 240a of the cylindrical member 240) of the fluorescent lamp socket 24, is obtained.

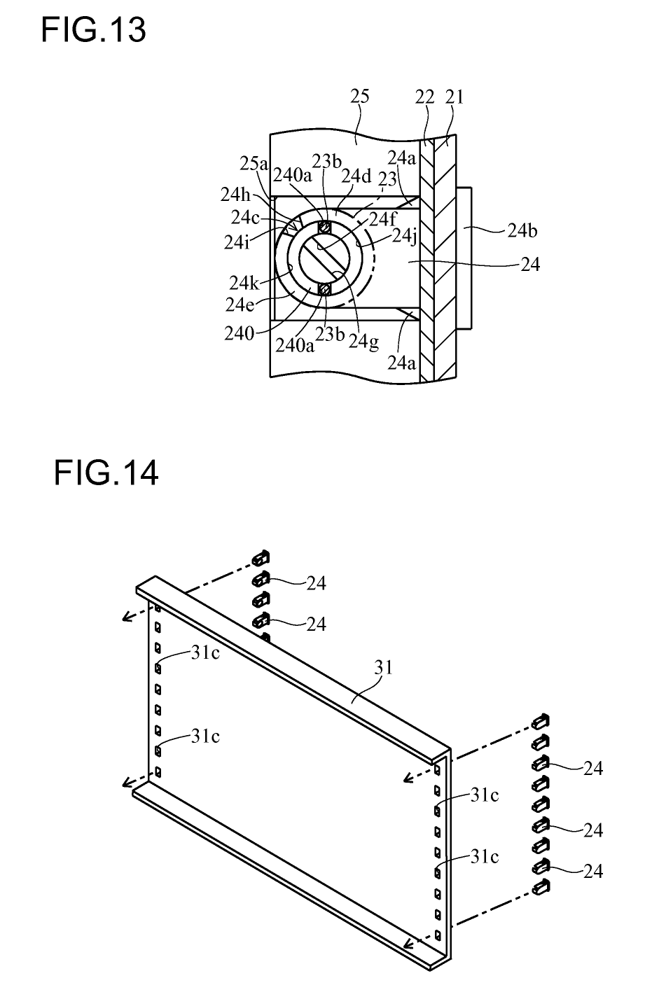

And, the terminals 23b of the hot-cathode fluorescent lamp 23 and the cylindrical member 240 are rotated in an arrow D direction (circumferential direction of the hot-cathode fluorescent lamp 23) by an angle (e.g., about 45 degrees) smaller than 90 degrees to move the terminal 23b of the hot-cathode fluorescent lamp 23 into the groove portions 24j and 24k. In this way, as shown in FIG. 13, a state in which the two terminals 23b of the hot-cathode fluorescent lamp 23 and the two slit portions 240a of the cylindrical member 240 come in a vertical direction, is obtained. At this time, engagement portions, not shown, engage with the claw portions 24d and 24e, so that the cylindrical member 240 is locked. In other words, the hot-cathode fluorescent lamp 23 is fixed to the fluorescent lamp socket 24. Besides, at this time, the terminal 23b of the hot-cathode fluorescent lamp 23 comes into contact with a not-shown metal piece disposed in the claw portions 24d and 24e, so that the hot-cathode fluorescent lamp 23 is electrically connected to the fluorescent lamp socket 24.

As described above, the mounting of the hot-cathode fluorescent lamp 23 onto the fluorescent lamp socket 24 of the backlight device 20 is performed.

In the present embodiment, as described above, because the insertion portion 24c of the fluorescent lamp socket 24 is formed in such a way that in the state in which the chassis 21 is vertically disposed (longitudinally disposed), the direction (arrow C direction), in which the hot-cathode fluorescent lamp 23 is demounted from the fluorescent lamp socket 24, faces an upper side than the horizontal direction, even in a case where the hot-cathode fluorescent lamp 23 is rotated by vibration and the like from outside, it is possible to prevent the terminal 23b of the hot-cathode fluorescent lamp 23 from coming off the insertion portion 24c of the fluorescent lamp socket 24. In this way, it is possible to prevent the hot-cathode fluorescent lamp 23 from falling from the fluorescent lamp socket 24. Besides, likewise, in the case where the mounting and demounting of the hot-cathode fluorescent lamp 23 are performed in the state in which the chassis 21 is vertically disposed (longitudinally disposed), it is possible to prevent the hot-cathode fluorescent lamp 23 from falling down (sliding down) from the fluorescent lamp socket 24 because of its weight.

Besides, in the present embodiment, the insertion portion 24c is formed in such a way that in the state in which the chassis 21 is vertically disposed (longitudinally disposed), the direction, in which the hot-cathode fluorescent lamp 23 is demounted from the fluorescent lamp socket 24, is inclined toward an upside with respect to the direction away from the chassis 21. In this way, unlike the case where the insertion portion 24c faces upward in the vertical direction in the state in which the chassis 21 is vertically disposed (longitudinally disposed), in mounting and demounting the hot-cathode fluorescent lamp 23, it is possible to prevent the hot-cathode fluorescent lamp 23 from coming into contact with the upper surface of the chassis 21 and prevent the hot-cathode fluorescent lamp 23 from coming into contact with another hot-cathode fluorescent lamp 23 arranged over. As a result of this, it is possible to easily mount and demount the hot-cathode fluorescent lamp 23.

Besides, in the present embodiment, because the claw portion 24e is so formed as to have a length longer than the claw portion 24d, it is possible to easily form the insertion portion 24c in such a way that in the state in which the chassis 21 is vertically disposed (longitudinally disposed), the direction, in which the hot-cathode fluorescent lamp 23 is demounted from the fluorescent lamp socket 24, faces an upper side than the horizontal direction.

Besides, in the present embodiment, because the end surface 24h of the claw portion 24d and the end surface 24i of the claw portion 24e are so formed as to be away from each other toward outside of the insertion portion 24c, it is possible to easily insert the hot-cathode fluorescent lamp 23 into the insertion portion 24c of the fluorescent lamp socket 24.

Besides, in the present embodiment, because the end surface 24i of the claw portion 24e is so formed as to be inclined toward the upside with respect to the direction away from the chassis 21 in the state in which the chassis 21 is vertically disposed, even in a case where after the hot-cathode fluorescent lamp 23 is rotated by vibration form outside, the terminal 23b of the hot-cathode fluorescent lamp 23 is moved to the end portion (end surfaces 24h and 24i) of the insertion portion 24c, it is possible to prevent the terminal 23b of the hot-cathode fluorescent lamp 23 from coming off (moving to outside of the end surface 24i) the end surface 24i. In this way, it is possible to prevent the hot-cathode fluorescent lamp 23 from coming off and falling from the fluorescent lamp socket 24.

Besides, in the present embodiment, because the opening portion 25a is formed through a portion of the cover member 25 that is situated in the direction in which the insertion portion 24c extends, in mounting and demounting the hot-cathode fluorescent lamp 23 onto and from the fluorescent lamp socket 24, it is not necessary to demount the cover member 25, so that it is possible to easily mount and demount the hot-cathode fluorescent lamp 23 onto and from the fluorescent lamp socket 24.

Besides, in the present embodiment, because the hot-cathode fluorescent lamp 23 is mounted onto the fluorescent lamp socket 24 by rotating the terminal 23b of the hot-cathode fluorescent lamp 23 in the arrow D direction by an angle smaller than 90 degrees, it is possible to more easily mount the hot-cathode fluorescent lamp 23 onto the fluorescent lamp socket 24 than a case where the hot-cathode fluorescent lamp 23 is mounted onto the fluorescent lamp socket 24 by rotating the terminal 23b of the hot-cathode fluorescent lamp 23 by 90 degrees or more.

Besides, in the present embodiment, the claw portions 24d and 24e are so structured as to have a function to limit movement of the hot-cathode fluorescent lamp 23 in the A direction (the axis direction of the hot-cathode fluorescent lamp 23). According to this, in the state in which the hot-cathode fluorescent lamp 23 is mounted on the fluorescent lamp socket 24, it is possible to limit movement of the hot-cathode fluorescent lamp 23 in the axis direction of the hot-cathode fluorescent lamp 23 with respect to the fluorescent lamp socket 24. Besides, in mounting and demounting the hot-cathode fluorescent lamp 23 onto and from the fluorescent lamp socket 24, it is possible to easily mount the hot-cathode fluorescent lamp 23 onto a desired position of the fluorescent lamp socket 24.

Here, it should be considered that the embodiment disclosed this time is an example in all respects and is not limiting. The scope of the present invention is not indicated by the above description of the embodiment but by the claims, and further all modifications within the scope of the claims and the meaning equivalent to the claims are covered.

For example, in the above embodiment, the examples are described, in which the display panel, the display device and the television receiver are applied to the liquid crystal display panel, the liquid crystal display device and the liquid crystal television receiver, respectively; however, the present invention is not limited to this, and the present invention may be applied to a display panel, a display device and a television receiver other than the liquid crystal display panel, the liquid crystal display device and the liquid crystal television receiver.

Besides, in the above embodiment, the example is described, in which the present invention is applied to the direct-type backlight device; however, the present invention is not limited to this, and the present invention may be applied to an edge-light type backlight device.

Besides, in the above embodiment, the example is described, in which the hot-cathode fluorescent lamp is used as an example of the light source; however, the present invention is not limited to this, and the present invention is applicable to a light source other than the hot-cathode fluorescent lamp.

Besides, in the above embodiment, the example is described, in which the two terminals are disposed on the lamp base portion; however, the present invention is not limited to this, and three or more terminals may be disposed on the lamp base portion.

Besides, in the above embodiment, the example is described, in which the hot-cathode fluorescent lamp is mounted onto the connector member by rotating the terminal of the hot-cathode fluorescent lamp by an angle smaller than 90 degrees; however, the present invention is not limited to this, and the hot-cathode fluorescent lamp may be mounted onto the connector member by rotating the terminal of the hot-cathode fluorescent lamp by 90 degrees or more. In this case, because it is possible to prevent the terminal of the hot-cathode fluorescent lamp from being rotated by vibration from outside and reaching the insertion portion, it is possible to further prevent the hot-cathode fluorescent lamp from coming off the connector member.

Besides, in the above embodiment, the example is described, in which the insertion portion is formed in such a way that in the state in which the chassis is vertically disposed (longitudinally disposed), the direction, in which the hot-cathode fluorescent lamp is demounted from the connector member, is inclined toward the upside with respect to the direction away from the chassis; however, the present invention is not limited to this, and the insertion portion may be formed in such a way that the direction in which the hot-cathode fluorescent lamp is demounted from the connector member faces upward in the vertical direction in the state in which the chassis is vertically disposed.

Besides, in the above embodiment, the example is described, in which the opening portion is formed through the cover member; however, the present invention is not limited to this, and the opening portion may not be formed through the cover member. In this case, in mounting and demounting the hot-cathode fluorescent lamp onto and from the connector member, the cover member is demounted from the chassis.

Besides, in the above embodiment, the example is described, in which the connector member is fixed to the chassis from the rear-surface side; however, the present invention is not limited to this, and the connector member may be fixed to the chassis from the front side.

Besides, in the above embodiment, the example is described, in which the insertion hole is formed through the reflection sheet; the chassis and the reflection sheet are sandwiched by the connector member by inserting the connector member into the insertion hole of the reflection sheet; however, the present invention is not limited to this, and a structure may be employed, in which the insertion hole is not formed through the reflection sheet; the length of the reflection sheet in the A direction is made shorter; and the connector member sandwiches the chassis only.

Besides, in the above embodiment, the example is described, in which the end surface 24h of the claw portion 24d and the end surface 24i of the claw portion 24e are so formed as to be away from each other toward outside of the insertion portion 24c; however, the present invention is not limited to this, and the end surface 24h of the claw portion 24d and the end surface 24i of the claw portion 24e may be so formed as to be parallel to each other.

Besides, in the above embodiment, the example is described, in which the reflection sheet is disposed on the front surface of the chassis; the fluorescent lamp socket is inserted into the insertion hole of the chassis and the insertion hole of the reflection sheet; however, the present invention is not limited to this, and like a backlight device according to a first modification of the present invention shown in FIG. 14, a structure may be employed, in which the reflection sheet is not disposed; for example, a ceramic coating is applied on a surface (inner surface) of a chassis 31 and the fluorescent lamp socket 24 is inserted into an insertion hole 31c only of the chassis 31.

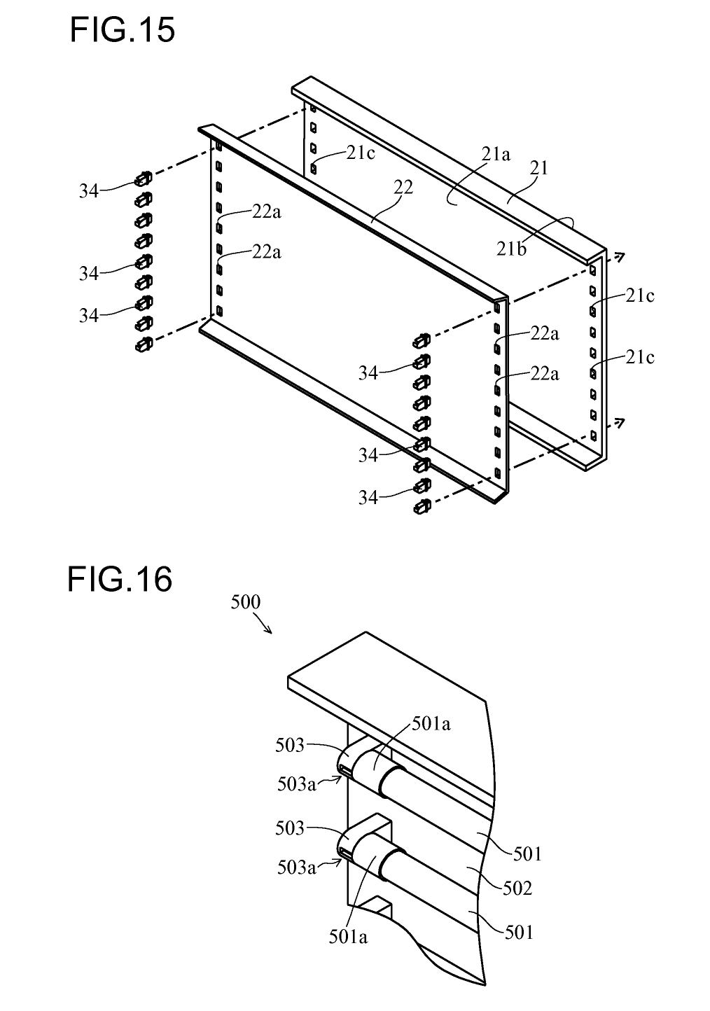

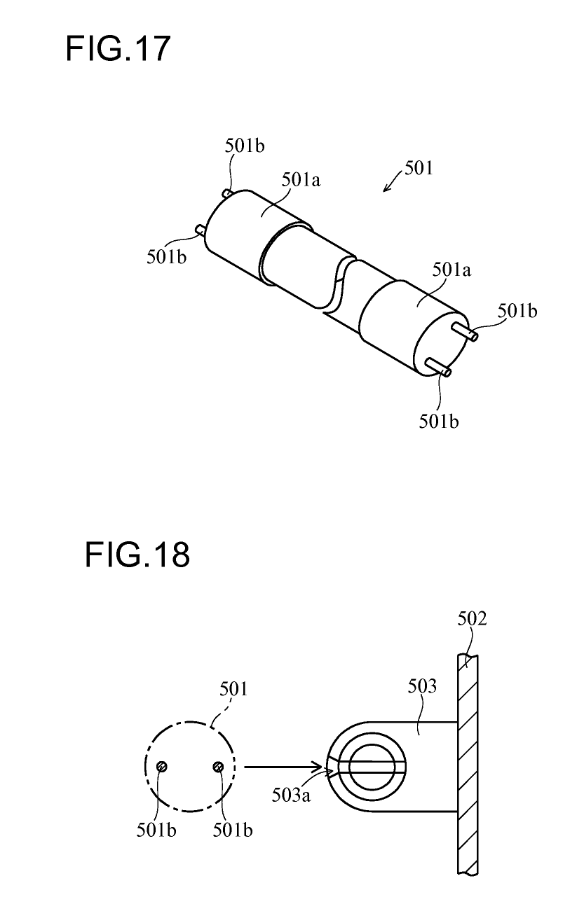

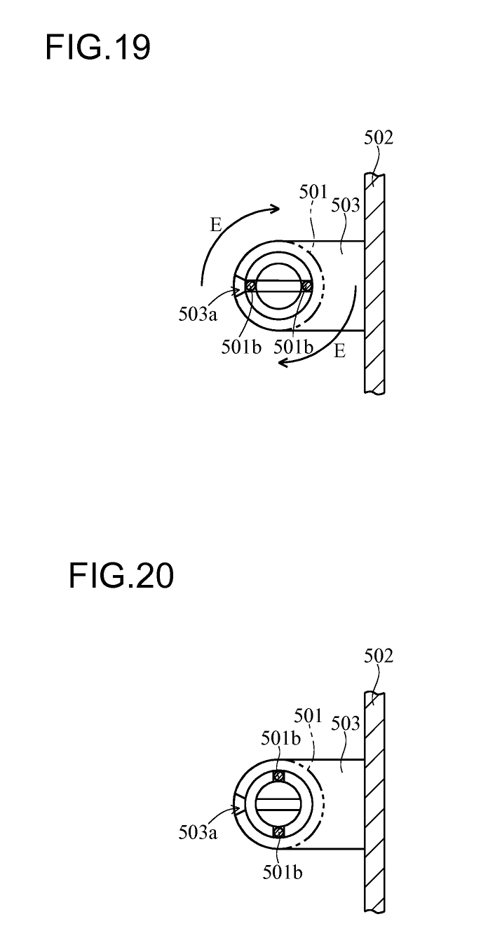

Besides, in the above embodiment, the example is described, in which the fluorescent lamp socket is inserted into the insertion hole of the chassis and into the insertion hole of the reflection sheet from the rear-surface side of the chassis; however, the present invention is not limited to this, and like a backlight device according to a second modification of the present invention shown in FIG. 15, a structure may be employed, in which a fluorescent lamp socket 34 is inserted into the insertion hole 22a of the reflection sheet 22 and into the insertion hole 21c of the chassis 21 from the front surface 21a side of the chassis 21.

1. A backlight device comprising:
a light source on both end portions of which lamp base portions each having a plurality of terminals are disposed;
a chassis that is disposed on a rear-surface side of the light source; and
a connector member that fixes the light source to the chassis; wherein the connector member is provided with an insertion portion into which the terminal of the light source is inserted; and
the insertion portion is formed in such a way that in a state in which the chassis is vertically disposed, a direction in which the light source is demounted from the connector member faces an upper side than a horizontal direction.

2. The backlight device according to claim 1, wherein
the insertion portion is formed in such a way that in the state in which the chassis is vertically disposed, the direction in which the light source is demounted from the connector member is inclined toward an upside with respect to a direction away from the chassis.

3. The backlight device according to claim 1, wherein
a first claw portion and a second claw portion, which have a first insertion surface and a second insertion surface respectively which constitute the insertion portion, are so formed on the connector member as to face each other;
the first claw portion is disposed over the second claw portion; and
the second claw portion has a length longer than the first claw portion.

4. The backlight device according to claim 3, wherein
an end portion of the first insertion surface of the first claw portion is provided with a first end surface;
an end portion of the second insertion surface of the second claw portion is provided with a second end surface; and
the first end surface of the first claw portion and the second end surface of the second claw portion are so formed as to be away from each other toward outside of the insertion portion.

5. The backlight device according to claim 4, wherein
the second end surface of the second claw portion is so formed as to be inclined toward an upside with respect to a direction away from the chassis in the state in which the chassis is vertically disposed.

6. The backlight device according to claim 1, further comprising a cover member that is fixed to the chassis and covers the connector member; wherein
a portion of the cover member, which is situated in a direction in which the insertion portion extends, is provided with an opening portion.

7. The backlight device according to claim 1, wherein
a first claw portion and a second claw portion, which have a first insertion surface and a second insertion surface respectively which constitute the insertion portion, are so formed on the connector member as to face each other;
the first claw portion and the second claw portion are provided with an arc-shape first groove portion and an arc-shape second groove portion respectively that are connected to the insertion portion; and
the terminals of the light source are inserted into the insertion portion of the connector member, rotated by a predetermined angle in a circumferential direction of the light source to be moved into the first groove portion and the second groove portion, so that the light source is mounted on the connector member.

8. The backlight device according to claim 7, wherein the predetermined angle by which the terminals of the light source are rotated is smaller than 90 degrees.

9. The backlight device according to claim 1, wherein the connector member is provided with a limit portion that limits movement of the light source in an axis direction of the light source.

10. A display device comprising:
the backlight device according to claim 1; and
a display panel that is illuminated by the backlight device.

11. A television receiver comprising:
the display device according to claim 10;
a cabinet that houses the display device;
a tuner; and
a speaker.
